(19) United States
(12) Patent Application Publication
(10) Pub. No.: US 2013/0084429 A1
(43) Pub. Date: Apr. 4, 2013

(54) METHOD FOR STAMPING A SHAPED FOAM ARTICLE

(71) Applicants: Matthew D. Mittag, Eden Prairie, MN (US); Myron J. Maurer, Saginaw, MI (US); Casey R. Fiting, Freeland, MI (US); Alain Sagnard, Lachen (CH)

(72) Inventors: Matthew D. Mittag, Eden Prairie, MN (US); Myron J. Maurer, Saginaw, MI (US); Casey R. Fiting, Freeland, MI (US); Alain Sagnard, Lachen (CH)

(73) Assignee: DOW GLOBAL TECHNOLOGIES LLC, Midland, MI (US)

(21) Appl. No.: 13/701,199

(22) PCT Filed: Jun. 21, 2011
(86) PCT No.: PCT/US2011/041149

§ 371 Date: Nov. 30, 2012

Related U.S. Application Data
(60) Provisional application No. 61/357,755, filed on Jun. 23, 2010.

(51) Int. Cl. B29C 44/56

(52) U.S. Cl. CPC B29C 44/5627
USPC 428/159; 264/48

(57) ABSTRACT

The invention relates to an improved method of cold forming a shaped foam article from a foam having a vertical compressive balance equal to or greater than 0.4 and one or more pressing surface and articles thereof. The improvement comprises the use of a stamping press to form the shaped foam article. Preferably, the stamping press is operated by mechanical or hydraulic means. The shaped foam article may be shaped on one or more surfaces.

### CROSS REFERENCE STATEMENT

This application claims the benefit of U.S. Provisional Application Ser. No. 61/357,755, filed Jun. 23, 2010, which is incorporated herein by reference.

### FIELD OF THE INVENTION

The invention relates to a method of forming, preferably cold forming, shaped foam plastic articles wherein the method uses a stamping process and articles formed there by.

### BACKGROUND OF THE INVENTION

Various methods and techniques are currently known and employed in the industry for shaping articles from a thermoplastic foam material, such as extruded polystyrene (XPS) foams. For example, shapes such as toys and puzzles can be die cut from foams that are formed by extruding a thermoplastic resin containing a blowing agent. There are also examples of foam sheet being shaped into articles such as dishes, cups, egg cartons, trays, and various types of food containers, such as fast food clam shells, take out/take home containers, and the like. More complex shaped foam articles can be made by thermoforming thermoplastic foam sheet. These methods lend themselves to the manufacture of relatively simple shaped articles from typically thin foams which are easily extracted from the molds used to produce them.

Recently, there have been significant advances in shaping more complex, and in particular, thicker thermoplastic foam (i.e., foams greater than 1 mm thick), shaped articles by pressing, or sometimes referred to as cold forming, unique foam compositions and/or structures, for example see USP Publication 2009-0062410 and WO 2010/011498. Conventional cold forming techniques utilize forming and/or shaping methods such as compression molding and roll forming. While some shapes are better suited for compression molding and other shapes are better suited for roll forming, either method is capable of providing suitable shaped articles. However, it would be desirable for an improved process to produce complex and/or thicker shaped foam articles which maximizes part production throughput by minimizing forming cycle time.

### SUMMARY OF THE INVENTION

The present invention is such a method for providing thicker and/or complex shaped foam articles in reduced cycle time. The present invention is a method for stamping one or more shaped foam article in a stamping press having a first die affixed too a ram and an optional second die affixed to a stationary bolster plate wherein the ram is capable of moving towards and away from the bolster plate comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has
   (i)(a) a vertical compressive balance equal to or greater than 0.4
   (i)(b) one or more pressing surface,
   and
   (i)(c) optionally cutting the foam plank to form a foam blank;
(ii) placing the foam plank/blank between the ram comprising the first die and the bolster plate optionally comprising the second die when the ram is away from the bolster plate;
(iii) moving the ram towards the bolster plate;
(iv) shaping the one or more pressing surface of the foam plank/blank into one or more shaped foam article and, if present, surrounding continuous unshaped foam plank/blank by
   (iv)(a) contacting the one or more pressing surface of the foam plank/blank with the die(s), said die(s) comprises one or a plurality of cavities each cavity having a perimeter defining the shape of the shaped foam article and a cavity surface, optionally wherein each cavity in the die affixed to the ram is defined by a trimming rib,
   (iv)(b) pressing the foam plank/blank with the die whereby forming one or more shaped foam article, and
   (iv)(c) optionally when trimming rib(s) are present, concurrently trimming each shaped foam article thus formed from the surrounding continuous unshaped foam plank/blank;
(v) moving the ram away from the bolster plate;
and
(vi) removing the one or more shaped foam article from between the ram and the bolster plate.

In one embodiment of the present invention, the ram in the method described herein above is operated by hydraulically or mechanically means.

In another embodiment of the present invention, the shaped foam article is shaped on only one side by the method described herein above wherein the top surface of the foam plank/blank has a pressing surface wherein said surface is the surface that is shaped.

In another embodiment of the present invention, the shaped foam article is shaped on two sides by the method described herein above wherein the top surface and the bottom surface of the foam plank/blank each have a pressing surface wherein both the top surface and the bottom surface are shaped.

In another embodiment of the present invention, the method described herein above wherein the foam has a cell gas pressure equal to or less than 1 atmosphere.

In another embodiment of the present invention, the method described herein above wherein the thermoplastic polymer is polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

In another embodiment of the present invention, the method described herein above wherein the blowing agent is a chemical blowing agent, an inorganic gas, an organic blowing agent, carbon dioxide, or combinations thereof.

Another embodiment of the present invention is a shaped foam article made by the method described herein above.

### BRIEF DESCRIPTION OF THE DRAWINGS

FIG. 1 is an illustration of a foam plank.

FIG. 2 is an illustration of a foam blank.

FIG. 3 is an illustration of a shaped foam article of the present invention.

FIG. 4 is a cross-sectional view of a forming tool for a stamping process with trimming rib in the open position.

FIG. 5 is a cross-sectional view of a forming tool for a stamping process with trimming rib in the closed position.

FIG. 6 is a diagrammatic view of a stamping line including one embodiment of the present invention.

FIG. 7 is a diagrammatic view of a stamping line including a second embodiment of the present invention.

FIG. 8 is a diagrammatic view of a stamping line including a third embodiment of the present invention.

### DETAILED DESCRIPTION OF THE INVENTION

The foamed article of the present invention can be made from any foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 20 percent or less, more preferably 10 percent or less and still more preferably 5 percent or less and most preferably one percent or less open cell content. Conversely, an open cell foam has 30 percent or more, preferably 50 percent or more, still more preferably 70 percent or more, yet more preferably 90 percent or more open cell content. An open cell foam can have 95 percent or more open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, polyisocyanurate foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for of the foam article of the present invention. Other thermoplastic polymers useful for the foam used in the present invention can comprise high impact polystyrene; styrene and acrylonitrile copolymer; acrylonitrile, butadiene, and styrene terpolymer; polycarbonate; polyethylene terephthalate; polyvinyl chloride; and blends thereof.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of their good balance between cost and property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides a higher water solubility than polystyrene homopolymer, thereby facilitating use of an aqueous blowing agent. SAN also has higher heat distortion temperature than polystyrene homopolymer, which provides a foam having a higher use temperature than a polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180,000, 175,000, 170,000, 165,000, 160,000, 155,000, 150,000, 145,000, 140,000, 135,000, 130,000, 125,000, 120,000, 115,000, 110,000, 105,000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer. Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein.

High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared by any conceivable method. Suitable methods for preparing polymeric foam articles include batch processes (such as expanded bead foam steam chest molding processes), semi-batch processes (such as accumulative extrusion processes) and continuous processes such as extrusion foam processes. Desirably, the process is a semi-batch or continuous extrusion process. Most preferably the process comprises an extrusion process, preferably by means of a single or twin screw extruder.

An expanded bead foam process is a batch process that requires the preparation of a foamable polymer composition by incorporating a blowing agent into granules of polymer composition (for example, imbibing granules of a thermoplastic polymer composition with a blowing agent under pressure). Each bead becomes a foamable polymer composition. Often, though not necessarily, the foamable beads undergo at least two expansion steps. An initial expansion occurs by heating the granules above their softening temperature and allowing the blowing agent to expand the beads. A second expansion is often done with multiple beads in a mold and then exposing the beads to steam to further expand them and fuse them together. A bonding agent is commonly coated on the beads before the second expansion to facilitate bonding of the beads together. The resulting expanded bead foam has a characteristic continuous network of polymer skins throughout the foam. The polymer skin network corresponds to the surface of each individual bead and encompasses groups of cells throughout the foam. The network is of higher density than the portion of foam containing groups of cells that the network encompasses.

Complex articles or blocks may be produced by steam chest molding. Blocks may be further shaped by cutting, for example by CNC hot wire, to a sheet of uniform thickness. A structural insulated panel (SIP) is an example of a steam chest molded block foam cut to a uniform thickness sheet and adhered to oriented strandboard OSB) or any other suitable facing.

The foamed article can also be made in a reactive foaming process, in which precursor materials react in the presence of a blowing agent to form a cellular polymer. Polymers of this type are most commonly polyurethane and polyepoxides, especially structural polyurethane foams as described, for example, in U.S. Pat. Nos. 5,234,965 and 6,423,755, both hereby incorporated by reference. Typically, anisotropic characteristics are imparted to such foams by constraining the expanding reaction mixture in at least one direction while allowing it to expand freely or nearly freely in at least one orthogonal direction.

An extrusion process prepares a foamable polymer composition of a thermoplastic polymer with a blowing agent in an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming. An extruded foam can be a continuous, seamless structure, such as a sheet or profile, as opposed to a bead foam structure or other composition comprising multiple individual foams that are assembled together in order to maximize structural integrity, thermal insulation and water absorption mitigation capability. An extruded foam sheet may have post-extrusion modifications performed to it as desired, for example edge treatments (e.g., tongue and groove), thickness tolerance control (e.g., via planning or skiving the surface), treatments to the top and/or bottom of the sheet, such as cutting grooves into the surface, laminating a monolithic or composite film and/or fabric, and the like.

Accumulative extrusion is a semi-continuous extrusion process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, hereby incorporated by reference, discloses such a process in a context of making polyolefin foams, yet which is readily adaptable to aromatic polymer foams. U.S. Pat. No. 3,268,636 discloses the process when it takes place in an injection molding machine and a thermoplastic with blowing agent is injected into a mold and allowed to foam, this process is sometimes called structural foam molding. Accumulative extrusion and extrusion processes produce foams that are free of such a polymer skin network.

Suitable blowing agents include one or any combination of more than one of the following: inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorintated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

Recent literature reveals that fluorinated olefins (fluoroalkenes) may be an attractive replacement for HFCs in many applications, including blowing agents, because they have a zero Ozone Depletion Potential (ODP), a lower Global Warming Potential (GWP) than HFCs, and high insulating capability (low thermal conductivity). See, for example United States patent application (USPA) 2004/0119047, 2004/0256594, 2007/0010592 and PCT publication WO 2005/108523. These references teach that fluoroalkenes can be suitable for blowing agents and are attractive because they have a GWP below 1000, preferably not greater than 75. USPA 2006/0142173 discloses fluoroalkenes that have a GWP of 150 or less and indicates a preference for a GWP of 50 or less. Particularly desirable fluorinated olefins include those described in WO 2008/118627.

The amount of blowing agent can be determined by one of ordinary skill in the art without undue experimentation for a given thermoplastic to be foamed based on the type of thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or less than about 160 kg/m³, more preferably equal to or less than about 120 kg/m³, and most preferably equal to or less than about 100 kg/m³.

The cells of the foam article may have an average size (largest dimension) of from about 0.05 to about 5.0 millimeter (mm), especially from about 0.1 to about 3.0 mm, as measured by ASTM D-3576-98. Foam articles having larger average cell sizes, of especially about 1.0 to about 3.0 mm or about 1.0 to about 2.0 mm in the largest dimension, are of particular use when the foam fails to have a compressive ratio of at least 0.4 as described in the following few paragraphs.

In one embodiment of the present invention, to facilitate the shape retention and appearance in the shaped foam article after pressing the shaped foam plank/blank, particularly foams comprising closed cells, it is desirable that the average cell gas pressure is equal to or less than 1.4 atmospheres. In one embodiment, it is desirable that the cell gas pressure is equal to or less than atmospheric pressure to minimize the potential for spring back of the foam after pressing causing less than desirable shape retention. Preferably, the average pressure of the closed cells (i.e., average closed cell gas pressure) is equal to or less than 1 atmosphere (101.3 kilo Pascal (kPa) or 14.7 pounds per square inch (psi)), preferably equal to or less than 0.95 atmosphere, more preferably equal to or less than 0.90 atmosphere, even more preferably equal to or less than 0.85 atmosphere, and most preferably equal to or less than 0.80 atmosphere.

Cell gas pressures may be determined from standard cell pressure versus aging curves. Alternatively, cell gas pressure can be determined according to ASTM D7132-05 if the initial time the foam is made is known. If the initial time the foam is made is unknown, then the following alternative empirical method can used: The average internal gas pressure of the closed cells from three samples is determined on cubes of foam measuring approximately 50 mm. One cube is placed in a furnace set to 85° C. under vacuum of at least 1 Torr or less, a second cube is placed in a furnace set to 85° C. at 0.5 atm, and the third cube is placed in the furnace at 85° C. at atmospheric pressure. After 12 hours, each sample is allowed to cool to room temperature in the furnace without changing the pressure in the furnace. After the cube is cool, it is removed from the furnace and the maximum dimensional change in each orthogonal direction is determined. The maximum linear dimensional change is then determined from the measurements and plotted against the pressure and curve fit with a straight line using linear regression analysis with average internal cell pressure being the pressure where the fitted line has zero dimensional change.

The compressive strength of the foam is determined in accordance with industry standard test methods such as ASTM D1621 or modifications thereof. The compressive strength of the foam article is established when the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, C_{V}/C_{T} and C_{H}/C_{T}, has a value of at least 0.40, preferably a value of at least 0.45, more preferably a value of at least 0.5, more preferably a value of at least 0.55, and more preferably a value of at least 0.60. When using such a foam, the pressing direction is desirably parallel to the maximum value in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

A most preferred foam article is a shaped foam article which may be prepared from a foamed polymer as described herein above in the form of a foam plank and further shaped to give a shaped foam article. The use of the term plank, herein, is merely used for convenience with the understanding that configurations other than a flat board having a rectangular cross-section may be extruded and/or foamed (e.g., an extruded sheet, an extruded profile, a pour-in-place bun, etc.). A particularly useful method to shape foam articles is to start from a foam plank which has been extruded from a thermoplastic comprising a blowing agent. As per convention, but not limited by, the extrusion of the plank is taken to be horizontally extruded (the direction of extrusion is orthogonal to the direction of gravity). Using such convention, the plank's top surface is that farthest from the ground and the plank's bottom surface is that closest to the ground, with the height of the foam (thickness) being orthogonal to the ground when being extruded.

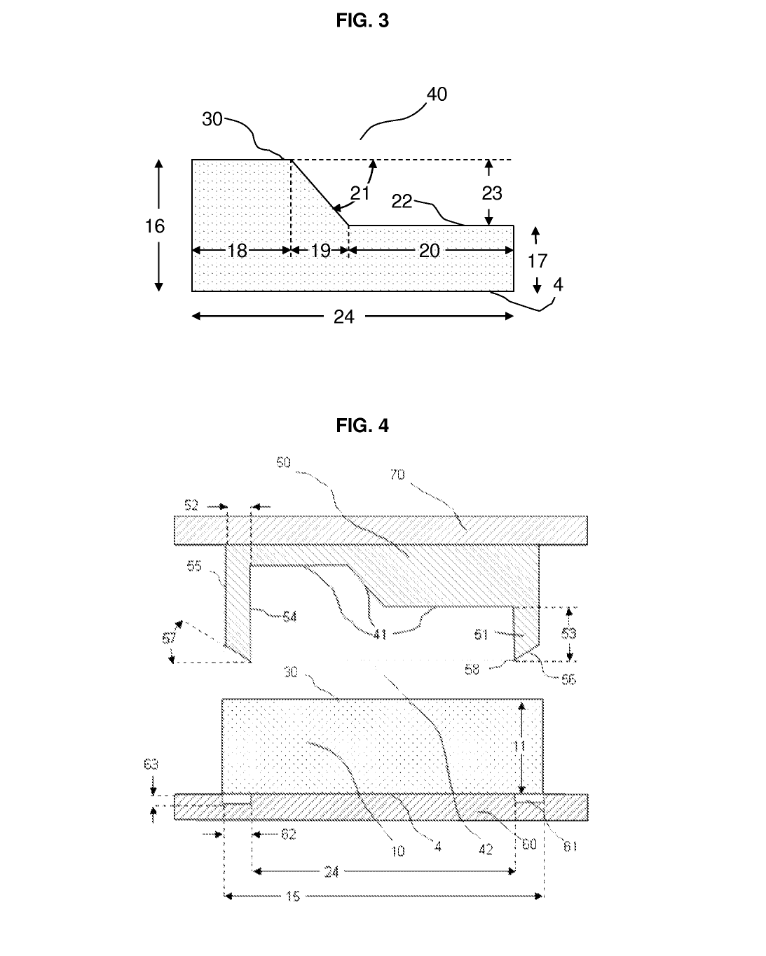

As defined herein, shaped means the foamed article typically has one or more contour that create a step change (impression) in height 23 of at least 1 millimeter or more in the shaped foam article 40 having thickness 16 as shown in FIG. 3. A shaped article has at least one surface that is not planar.

The forming of the shaped foam articles is surprisingly enhanced by using foam planks 1 that have at least one direction where at least one of C_{E}/C_{T}, C_{V}/C_{T} and C_{H}/C_{T} is at least 0.4 said one of C_{E}/C_{T}, C_{V}/C_{T} and C_{H}/C_{T} (compressive balance), C_{E}, C_{V} and C_{H} being the compressive strength of the cellular polymer in each of three orthogonal directions E, V and H where one of these directions is the direction of maximum compressive strength in the foam and C_{T} equals the sum of C_{E}, C_{V} and C_{H}.

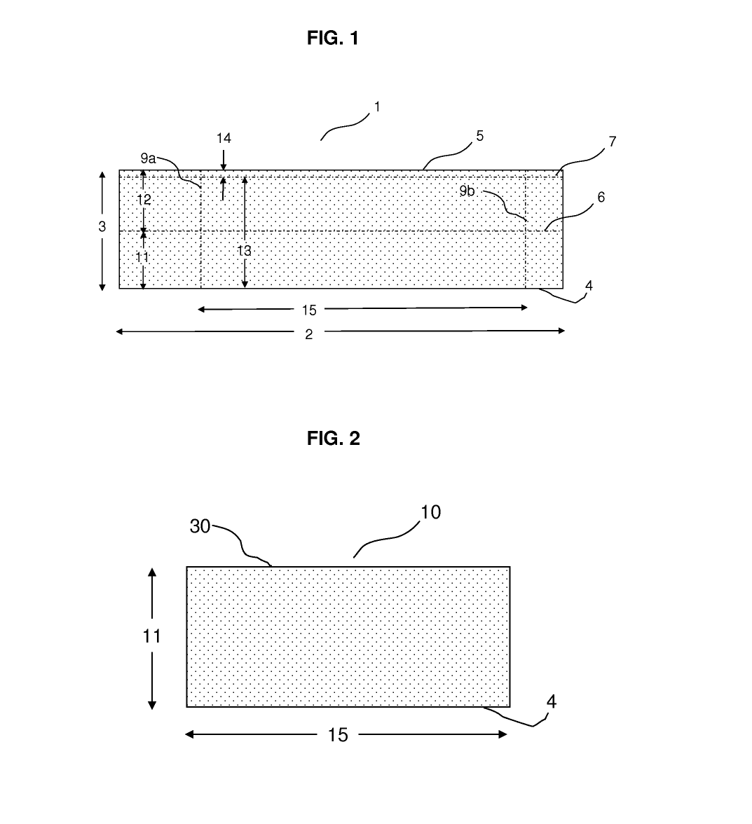

After the foam plank 1 is formed FIG. 1, a pressing surface is created 30, for example by removing a layer from the top 7 or bottom surface of the foam plank or by cutting 6 the foam plank between the top and bottom surface to create two pressing surfaces opposite the top and bottom surface. Suitable equipment useful for preparing a pressing surface are band saws, computer numeric controlled (CNC) abrasive wire cutting machines, CNC hot wire cutting equipment and the like. When removing a layer, the same cutting methods just described may be used and other methods such as planing, grinding or sanding may be used.

Typically, after removing a layer from the top and/or bottom surface of the foam plank and/or cutting the plank, the resulting plank with pressing surface is at least about several millimeters thick to at most about 60 centimeters thick. Generally, when removing a layer, the amount of material is at least about a millimeter and may be any amount useful to perform the method such as 1.2, 1.4, 1.6, 1.8, 2, 2.5, 3, 3.5, 4, 5 millimeters or any subsequent amount determined to be useful such as an amount to remove any skin that is formed as a result of extruding the thermoplastic foam, but is typically no more than 10 millimeters. In another embodiment, the foam is cut and a layer is removed from the top or bottom surface opposite the cut surface to form two pressing surfaces.

In a particular embodiment, the cut foam plank FIG. 2 having a pressing surface 30, has a density gradient from the pressing surface to the opposite surface of the foam plank 4. Generally, it is desirable to have a density gradient of at least 5 percent, 10 percent, 15 percent, 25 percent, 30 percent or even 35 percent from the pressing surface to the opposing surface of the foam plank. To illustrate the density gradient, if the density of the foam at the surface (i.e., within a millimeter or two of the surface) is 3.0 pounds per cubic foot (pcf), the density would be for a 10 percent gradient either 2.7 or 3.3 pcf at the center of the foam. Preferably, the local density at the pressing surface is lower than the local density at the opposite surface (non-pressing surface) of the foam plank/blank respectively. Thus, when the non-pressing surface has a density of 3 pcf, it is desired for the pressing surface to be 2.7 pcf.

In one embodiment of the present invention FIG. 3, the shaped foam article 40 may be formed in a foam plank 1 and in a subsequent and separate step, the shaped foam article is separated, or trimmed from the continuous unshaped foam plank. In another embodiment, the plank 1 may be cut 8 at one or more locations 9a and/or 9b to fit into a forming tool prior to contact with the tool, the cut foamed plank is sometimes referred to as a foam blank 10. In another embodiment, the final shape maybe cut from the pressed plank, for example, the foam plank 1 with one or more pressing surface may be pressed to form a shaped foam article which is subsequently cut from the pressed foam plank. When cutting the foam, any suitable method may be used, such as those known in the art and those described previously for cutting the foam to form the pressing surfaces. In addition, methods that involve heat may also be used to cut the foam since the pressed shape has already been formed in the pressing surface.

In yet another, preferred embodiment, the shaped foam article is trimmed from the continuous unshaped foam plank/blank by a trimming rib simultaneously as the shaped foam article is formed. Each cavity 42 of the die or mold 50 on the movable platen 70 is defined by a trimming rib 51 with a thickness 52, a height 53, an inside surface 54, an outside surface 55, and a trimming end 56. It is the rib inside surface 54, or the inner perimeter of the trimming rib, that defines the outline of the cavity. The trimming rib separates the shaped foam article 40 from the surrounding continuous unshaped foam plank/blank.

The thickness 52 of the trimming rib 51, is equal to or greater than about 0.05 inches, preferably equal to or greater than about 0.13 inches, more preferably equal to or greater than about 0.25 inches, and most preferably equal to or greater than about 0.38 inches. The thickness 52 of the trimming rib 51, is equal to or less than about 1 inch, preferably equal to or less than about 0.75 inches, more preferably equal to or less than about 0.63 inches, and most preferably equal to or less than about 0.5 inch.

The trimming end 56 of the rib may have any configuration which satisfactorily trims the foam, preferably the trimming end of the rib is beveled towards or away from the cavity it surrounds, most preferably the bevel is towards the cavity. In other words, the furthest point of the trimming end of the trimming rib 58 defines the outline of the cavity. When the end of the trimming rib is beveled, the angle of the bevel 57 is greater than 0°, preferably equal to or greater than about 5°, preferably equal to or greater than about 10°, preferably equal to or greater than about 20°, and most preferably equal to or greater than about 30°. When the end of the trimming rib is beveled, the angle of the bevel 57 is less than 90°, preferably equal to or less than about 80°, preferably equal to or less than about 70°, and most preferably equal to or less than 60°.

A die or mold may have one or more trimming rib. For each trimming rib independently, the trimming rib height 53 is the distance from the inside surface of the cavity adjacent to the trimming rib 41 to the furthest point 58 of the trimming end 56 of the trimming rib 51.

A useful parameter is the final distance from the surface of the stationary forming surface on which the foam plank/blank is placed to the corresponding inside surface of the cavity when the movable platen is in its closest proximity to the stationary platen during the molding cycle. Depending on the shape of the shaped foam article, there may be one or more final distance within a cavity, for example 16 and 17. If there is more than one final distance, the one with the greatest value is defined as the maximum final distance 16 and the one with the smallest value is defined as the minimum final distance 17. The final distance(s) will describe the thickness of the shaped foam article as molded 40 prior to elastic recovery of the foam, if any.

We have found that the ratio of the trimming rib height (hᵣ) to the minimum final distance (d_{f min}) hᵣ/d_{f min} is preferably equal to or greater than about 90 percent, more preferably equal to or greater than about 100 percent, and most preferably equal to or greater than about 110 percent. We have found that the ratio of the trimming rib height to the minimum final distance hᵣ/d_{f min} is preferably equal to or less than about 200 percent, more preferably equal to or less than about 150 percent, and most preferably equal to or less than about 125 percent.

The stationary forming surface on which the foam plank/blank is placed prior to shaping/trimming step is typically a stationary platen 60, however in one embodiment, the stationary platen may comprise a holding or aligning means for the foam plank/blank or a forming tool, such as a die or mold paired with the die or mold on the movable platen, or the like. Preferably, the trimming rib does not contact the stationary forming surface, e.g., the stationary platen, holding or aligning means, forming tool, and/or mold. The stationary forming surface may comprise one or a plurality of grooves 61, each groove independently having a width 62 and a depth 63. Said groove(s) 61 align with the corresponding trimming rib(s) 51 of each cavity 42 in the forming tool 50 on the movable platen 70 such that when the movable platen is moved towards the stationary platen, the trimming rib may extend into its corresponding groove in the stationary forming surface. The groove(s) need not be any wider and/or deeper than necessary than what is required to allow for full, unimpeded penetration of the trimming rib when the movable platen 70 is positioned in its closest proximity 45 to the stationary platen 60 during the molding cycle.

The width of the groove, 62, is equal to or greater than about 101 percent of the trimming rib thickness 52, preferably equal to or greater than about 105 percent of the trimming rib thickness 52, preferably equal to or greater than about 110 percent of the trimming rib thickness 52, preferably equal to or greater than about 115 percent of the trimming rib thickness 52, and most preferably equal to or greater than about 120 percent of the trimming rib thickness 52. The width of the groove, 62, is equal to or less than about 200 percent of the trimming rib thickness 52, preferably equal to or less than about 175 percent of the trimming rib thickness 52, preferably equal to or less than about 150 percent of the trimming rib thickness 52, preferably equal to or less than about 135 percent of the trimming rib thickness 52, and most preferably equal to or greater than about 125 percent of the trimming rib thickness 52.

The minimum depth of the groove (d_{g min}) 64, is equal to the difference between the height of the trimming rib (hᵣ) 53 minus the distance the inside surface of the cavity adjacent to the trimming rib is from the stationary platen (d_{isc}) 17 when the movable platen is in its closest proximity during the molding cycle 45, d_{g min}≧hᵣ−d_{isc}. The depth of the groove (d_{g}) 63, is preferably equal to or greater than about 101 percent of d_{g min}, preferably equal to or greater than about 105 percent of d_{g min}, preferably equal to or greater than about 110 percent of d_{g min}, preferably equal to or greater than about 115 percent of d_{g min}, and most preferably equal to or greater than about 120 percent of d_{g min}. The depth of the groove, d_{g}, is equal to or less than about 200 percent of d_{g min}, preferably equal to or less than about 175 percent of d_{g min}, preferably equal to or less than about 150 percent of d_{g min}, preferably equal to or less than about 135 percent of d_{g min}, and most preferably equal to or greater than about 125 percent of d_{g min}.

The process of the present invention uses a stamping press to shape the foam plank/blank into a shaped foam article by deforming the foam plank/blank with a forming tool or die (also referred to herein as a mold). This process is often referred to as discontinuous as it consists of a cycle where a foam plank/blank is placed in an open die, the die closes to form an article, and after the article is formed the die opens. The shaped foam article is removed from the opened die, a new foam plank/blank is inserted in the open die and the process is repeated. By design, stamping processes have a significantly shorter cycle time than such conventional plastic forming processes such as compression molding. Preferred cycle times (the time interval for the die open/close cycle) are equal to or less than 60 seconds, preferably equal to or less than 50 seconds, more preferably equal to or less than 40 seconds, more preferably equal to or less than 30 seconds, more preferably equal to or less than 20 seconds, more preferably equal to or less than 10 seconds, more preferably equal to or less than 5 seconds, and most preferably equal to or less than 2 seconds.

Stamping presses and their use are well known. A stamping press has a press frame, a bolster plate and a ram. The bolster plate (or bed) is a large block of metal upon which, optionally, the bottom portion of a tool or die (if present) is affixed or clamped; the bolster plate is stationary. The ram is also a solid piece of metal to which is affixed or clamped the top portion of a (progressive) stamping tool or die and which provides the stroke towards and away (up and down or open and closed movement) the bolster plate. When the ram is down, or the die is in the closed position, the die presses against a pressing surface of the foam shaping the foam into shaped foam article.

Stamping presses can be subdivided into mechanically driven presses and hydraulically driven presses. The most common mechanical presses use an eccentric drive to move the press's ram, provided by cam action, cranks, toggles, and the like, whereas hydraulic cylinders are used in moving the rams of hydraulic presses. The nature of drive system determines the force progression during the ram's stroke. One advantage of the hydraulic press is the constant press force during the stroke. Mechanical presses have a press force progression towards the bottom dead center depending on the drive and hinge system. Mechanical presses therefore can reach higher cycles per unit of time and are preferably the press of choice when trying to maximizing article through-put.

For the process of the present invention, both mechanical and hydraulic presses may be suitably used. The selection of which type of press to be used depends on the shaped foam article to be made, the compressive strength of the foam, size of the part, applied strain and/or the desired target cycle time.

Typically, presses are electronically linked (with a programmable logic controller) to an automatic feeder which feeds the foam blank through the die. The foam blank is fed into the automatic feeder after a pressing surface has been created and the blank is trimmed to the appropriate size. A tonnage monitor may be provided to observe the amount of force used for each stroke.

The method for stamping one or more shaped foam article uses a stamping press having a first and a second relatively moving mold halves or dies and a press ram for opening/closing the mold haves or dies. The stamping press has a stationary platen (e.g, the bolster plate) and a movable platen (e.g., the ram) to which a forming tool (e.g., dies or molds) may be affixed. A foam plank/blank is placed between the ram (with an affixed die) and the bolster plate (optionally fitted with a die) when the ram is in the open position. The ram is moved towards the bolster plate and the pressing surface(s) of the plank/blank is contacted with the die face(s) or mold as the ram is closed.

Herein die face and/or mold means any tool having an impressed shape and/or cavity that when pressed into the foam plank/blank will cause the foam to take the shape of the die face. That is, the material making up the forming tool is such that it does not deform when pressed against the foam plank/blank, but the foam plank/blank deforms to form and retain the desired shape of the forming tool, die face, and/or mold cavity. Typically, a die or mold comprises a cavity portion, or cavity half and a core portion, or core half. The cavity half of the die or mold may be affixed to the stationary platen, but more often is affixed to the movable platen. Hereinafter, when the die or mold half with a cavity is affixed to the movable platen is referred to as the movable forming surface and the stationary platen is referred to as the stationary forming surface. The stationary platen may or may not have a die or mold half with a core affixed to it. Alternatively, both die or mold haves may comprise a core, a cavity, or a combination of both depending on the design of the shaped foam article.

In the process of the present invention, a foam plank 1 is produced, preferably by extrusion, one or more pressing surface 30 is created on the foam plank, optionally, the foam plank, with one or more pressing surface, is cut 8 to a specific size providing a foam blank 10 with one or more pressing surface. The foam plank/blank is placed between the die haves in an open press 101, any means to deliver the foam plank/blank into the press between the open die haves is acceptable, the foam plank/blank is then shaped into a shaped foam article 40 by closing 102 the movable die half (affixed to the ram) to the desired position, the die halves are opened 103 so that the one or more shaped foam article and, if present, any excess foam trimmed from the surrounding continuous unshaped foam plank/blank may be removed 104, after removal of the one or more shaped foam article, a new foam plank/blank is inserted between the die haves, and the process is repeated. Any excess foam material that is not used to form the shaped foam article, e.g., excess trimmed form the shaped foam article, may be recovered and recycled. Recycling methods are well known; any suitable method to recycle foam material is acceptable.

FIG. 6 to FIG. 8 are representative of a stamping line of the present process having one or more die set (100a, 100b, and 100c) for shaping a foam plank/blank into a shaped foam article of the present invention, the stamping press is not depicted in the drawings.

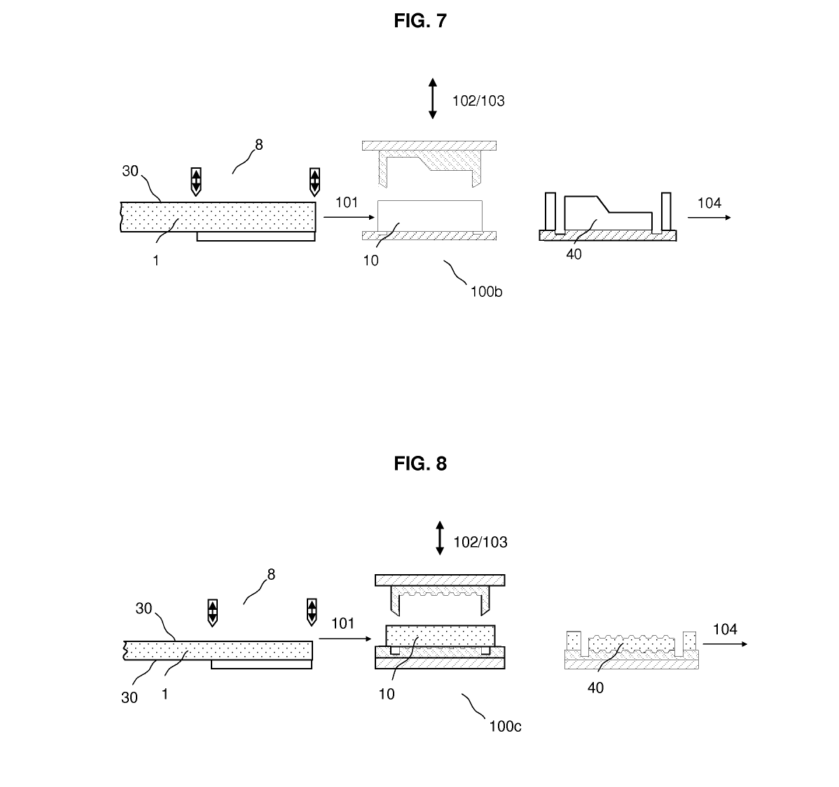

Depending on the design of the shaped foam article, it may be formed on one or more sides, typically a top side or a top and bottom side (referred to as a double-sided shaped foam article). Further, the foam plank/blank may be shaped into the shaped foam article without trimming and/or any resulting scrap of the foam plank/blank, FIG. 6. Alternatively, the foam plank/blank may be trimmed during the process of stamping (forming). Trimming may be accomplished by means of forming ribs in the tool, FIG. 7 and FIG. 8.

One or both sides of the foam plank/blank may be shaped. In one embodiment of the present invention FIG. 6, only one surface of the foam plank/blank is shaped 100a. In this embodiment, the foam article is shaped only on one surface pressed by the platen having the half of the die with the cavity. In this embodiment, the foam plank/blank may be pressed directly against the other platen or against a die half with a core affixed to the other platen.

In another embodiment of the present invention FIG. 7, the foam article is shaped only on one surface pressed by the platen having the half of the die with the cavity and trimmed concurrently during the pressing step via trimming rib(s) 100b. In this embodiment, the foam plank/blank may be pressed directly against the other platen or against a die half with a core affixed to the other platen.

In another embodiment of the present invention (not depicted in the drawings), two surfaces of the foam plank/blank are shaped, the top and the bottom surfaces without any trimming of excess foam. In this embodiment, there is a die half on the stationary platen and both halves of the die impart shape to the foam plank/blank.

In another embodiment of the present invention FIG. 8, two surfaces of the foam plank/blank is shaped, the top and the bottom surfaces, and trimmed. In this embodiment, there is a die on the movable platen and the stationary platen wherein both dies impart shape to the foam plank/blank and the shaped foam article is trimmed concurrently during the pressing step via trimming rib(s) 100c.

Typically when pressing, at least a portion of the foam is pressed such that the foam is compressed to a thickness of 95 percent or less of the to-be-pressed foam thickness 17 as shown in FIG. 3, which typically corresponds to just exceeding the yield stress of the foam (elastically deforming the foam). Likewise, when pressing the part, the maximum deformation of the foam (elastically deforming the foam) is typically no more than about 20 percent of the original thickness 11 of the foam blank 10 ready to be pressed. In other words, the final thickness of the pressed foam (shaped foam article) is equal to or less than 80 percent of the original thickness of the foam blank.

The forming tool, because a shape is most often desired, typically has contours that create an impression (step change) in height 23 of at least a millimeter in the shaped foam article 40 having thickness from one end of the step change 16 to the other 17 as shown in FIG. 3. The height/depth 23 of an impression may be measured using any suitable technique such as contact measurement techniques (e.g., coordinate measuring machines, dial gauges, contour templates) and non-contact techniques such as optical methods including laser methods. The height of the step change 23 may be greater than 1 millimeter such as 1.5, 2, 2.5, 3, 3.5, 4, 5, 6, 7, 8, 9 and 10 to a height that is to a point where there are no more foam cells to collapse such that pressing further starts to elastically deform the plastic (polymer) of the foam.

The step change, surprisingly, may be formed where the foam undergoes shear. For example, the foam may have a shear or draft angle 21 (θ) of about 45° to about 90° from the pressing surface 30 of the foam in a step change of height 23. It is understood that the shear angle θ may not be linear, but may have some curvature, with the angle in these cases being an average over the curvature. The angle surprisingly may be greater than 60°, 75° or even by 90° while still maintaining an excellent finish and appearance. The draft angle at any point along the die or mold surface is defined as the tangent of the angle taken at that location of the mold.

In another aspect of the invention, a foam having a higher concentration of open cells at a surface of the foam than the concentration of open cells within the foam is contacted and pressed to form the shape. In this aspect of the invention the foam may be any foam, preferably a styrenic foam such as the extruded styrenic polymer foam described above. It may also be any other styrenic polymeric foam such as those known in the art including, for example, where the blowing agent is added to polymer beads, typically under pressure, as described by U.S. Pat. No. 4,485,193 and each of the U.S. patents cited hereinabove.

With respect to this open cell gradient, the gradient is as described above for the density gradient where the concentration of open cells if determined microscopically and is the number of open cells per total cells at the surface.

Generally, the amount of open cells in this aspect of the invention at the surface is at least 5 percent to completely open cell. Desirably, the open cells at the surface is at least in ascending order of 6 percent, 7 percent, 8 percent, 10 percent, 20 percent, 30 percent, 40 percent, 50 percent, 60 percent, 70 percent, 80 percent, 90 percent and completely open cell at the surface.

The foam may have the open cells formed at the surface by mechanical means such as those described above (e.g., planing/machining or cutting) or may be induced chemically, for example, by use of suitable surfactants to burst closed cells at the surface.

The foam surface with the higher concentration of open cells is contacted with a forming tool and pressed as described above. In a preferred embodiment for such foams, one or both sides of the forming tool, e.g., both sides of the die face and/or mold are heated, but the foam is not (ambient 15-30° C.) and the foam is pressed. Surprisingly, heating the die faces with the foams having open cells at the surface results in superior surface contour and appearance as compared to doing the same with a foam without such open cells at the surface, in this case, the appearance of the foam is degraded.

In another embodiment of the present invention, the shaped foam article may be perforated. Such an article may have a plurality of perforations. Perforation is defined herein to mean one or more hole which passes through the foam plank/shaped article one surface to another, i.e., from the top surface to the bottom surface. Perforation may occur at any time, in other words, it may be done to the foam plank prior to shaping, to the shaped foam article, or a combination of the two. The perforations extend through the shaped foam article, for instance for a shaped foam article made from a foam plank, through the depth of the foam plank. The foam may be perforated by any acceptable means. Perforating the foam article may comprise puncturing the foam article with a one or more of pointed, sharp Objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

When pressing with a heated forming tool, the contact time with the foam is typically from about 0.1 second to about 60 seconds. Preferably, the dwell time is at least about 1 second to at most about 45 seconds. Dwell time is defined as the duration at which the forming tool remains stationary with the foam subjected to maximum applied strain.

When pressing with a heated forming tool, the temperature of the forming tool is not so hot or held for too long a time such that the foam is degraded. Typically, the temperature of the forming tool is about 50° C. to about 200° C. Preferably, the temperature is at least about 80°, more preferably at least about 100° C., even more preferably at least about 120° C. and most preferably at least about 140° C. to preferably at most about 190°, more preferably at most about 180°, even more preferably at most about 170° C. and most preferably at most about 160° C.

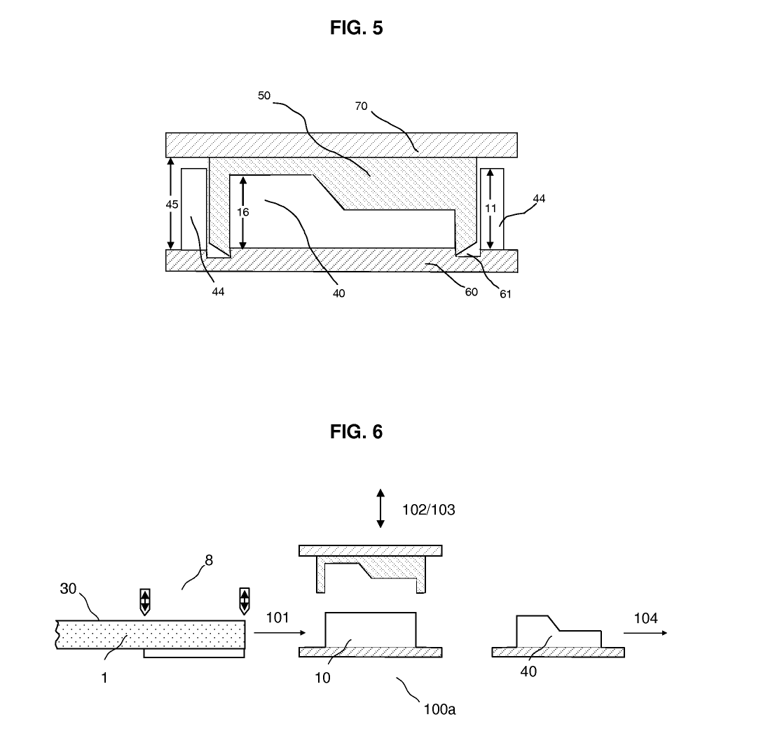

The forming tool or die provides the shape to the shaped foam article. The forming tool comprises the forming cavity (shape) and all the necessary equipment for temperature control, trimming, etc. The most frequent case, the forming tool, such as a die or mold, comprises two halves, one which may be the stationary platen 60 or which is mounted to a stationary platen (sometimes referred to as the core side or stationary forming surface), the other die or mold half 50 to a moveable platen 70 (sometimes referred to as the cavity side or movable forming surface) and moving with it. The shape of the article will dictate the design and complexity of the forming tool. In the simplest case, the die or mold half with the cavity is affixed to the movable platen and the stationary forming surface (e.g., bolster plate) is the stationary platen itself 60 FIG. 4 to FIG. 7. In a preferred embodiment of the present invention, the stationary forming surface is flat, in other words, imparts no shape to the foam plank/blank and the movable forming surface, or cavity, has a defined shape which is imparted into the foam plank/blank pressing surface 30 when impressed upon the foam plank/blank FIG. 4 to FIG. 7. In another embodiment of the present invention FIG. 8, both the stationary and movable forming surfaces of the forming tool impart shape to the foam plank/blank. Conventional materials of construction are used for the die or mold such as, but not limited to: aluminum, composites (i.e. epoxy), wood, metal, porous tooling such as METAPOR™, and the like.

In one embodiment of the present invention the shaping/trimming step of the present invention, the surface of the foam plank/blank opposite the pressing surface(s) 30 of the foam plank/blank is placed on a stationary forming surface, such as a bolster plate (e.g., stationary platen) 60. The movable ram (e.g., movable platen) 70 which can move toward or away from the stationary platen on which the foam plank/blank is placed comprises a movable forming surface of the forming tool 50, for example, a single cavity die or mold or optionally a multiple cavity die or mold. To shape the foam, the movable platen moves towards the stationary platen such that the one or more pressing surface of the foam plank/blank 30 is contacted and pressed with the movable forming surface of the forming tool 50. For a multi-cavity mold, each cavity may be identical in shape or there may be as many different shapes as cavities or there may be a combination of multiple cavities with the same first shape in combination with multiple cavities with one or more shapes different than the first shape. The layout of cavities in a multi-cavity mold may be side by side, in tandem, or any other desirable configuration. A multi-cavity mold produces more than one shaped article in a plank per molding cycle.

In another embodiment of the present invention, each cavity surface of the mold or die has a reduced-slip surface sufficient to reduce cracking in the formed shaped foam article, for example by at least 50 percent versus the formed shaped foam article pressed by a cavity with a smooth cavity surface. Preferably, when the shaped foam article has a maximum draft angle (θ) each cavity in the mold or die has a reduced-slip cavity surface having a static friction coefficient (μ) between the cavity surface and the foam plank wherein the relationship between the maximum draft angle and the static friction coefficient is defined by the formula:

μ≧tan(θ).

The reduced-slip cavity surface of the present invention is produced by applying sandpaper to the cavity surface; adhering sand directly to the cavity surface; chemically etching the cavity surface; electro eroding the cavity surface; coating the cavity surface with rubber, silicon, plasma, textured paint, or a sticky coating; texturing the cavity surface; sand blasting the cavity surface; media blasting the cavity surface; embossing the cavity surface; scratching the cavity surface; milling the cavity surface; forming protrusions on the cavity surface, forming indentations on the cavity surface; forming micro perforations on the cavity surface; forming ribs on the cavity surface; forming needles on the cavity surface; forming serrated blades on the cavity surface; heating the foam and/or the pressing surface of the mold to a point where the foam's pressing surface becomes sticky; vacuum applied through the pressing surface of the mold; or combinations thereof. Most preferably, each cavity surface is textured

Another embodiment of the present invention further provides for forming a shaped foam article with reduced warpage, fewer cracks, and/or less read-through while optimizing material utilization and lowering overall article material costs by cutting the foam plank to form a near net-shape foam blank with one or more pressing surface. The term ‘near net-shape foam blank’ is used to describe a foam plank/blank wherein a first cut provides shape to the blank as well as a pressing surface (not depicted in the accompanying drawings). In other words, the cut provides a two dimensional shape to the foam blank which approximates (is ‘near’ to) the shape or contour of the final (‘net-’) shaped foam article. The cut surface becomes the first pressing surface, if the opposite surface of the blank is also cut or removed the resulting surface becomes the second pressing surface. In comparison to conventional blank preparation, rectangular foam blanks required a cut to prepare a pressing surface so the cut in the near net-shaped foam blank of the present invention does not necessitate an additional step.

For example, the near net-shaped foam blank is cut from a foam plank wherein the cut is not parallel to the top or bottom surface of the foam plank. For a cut defined as a non-parallel plane through the foam plank, two near net-shaped foam blanks having a tapered shape are produced. Depending on how the cut is applied (specifically the angle and depth where the cut starts and stops through the plank), the resulting two tapered near net-shaped foam blanks may have the same dimensions or different dimensions. A tapered near net-shaped foam blank used in the process of the present invention improves raw material utilization and reduces raw material costs as compared to a conventional rectangular foam blank. For example, if a depth, d_{b} is required in a foam blank to produce a foam article two conventional rectangular foam blanks would require a foam plank having a depth of d_{f} equal to or greater than 2d_{b}, in other words, at least twice as much material. However, since near net-shaped foam blanks can nest, or be complementary in shape, two near net-shape foam blanks can be cut from a foam plank of depth less than 2d_{b}. Further, a foam article shaped from a conventional rectangular foam blank will have a density (weight) greater than that of a shaped foam article made from a near net-shaped foam blank.

In another example, the near net-shaped foam blank for such an article cut from the foam plank is a sinusoidal shaped blank. Like the example of the tapered near net-shaped foam blank above, a sinusoidal cut may provide two identical near net-shaped foam blanks from a single foam plank. For this kind of shape, the two cut near net-shaped foam blanks effectively ‘nest’ with each other and can result in improved raw material utilization as much as 100 percent while cutting the raw material costs by as much a half.

The following shapes are representative, but this list is neither limiting nor inclusive, as to the shapes a near net-shaped foam blank may comprise: tapered, sinusoidal, triangular, stepped, zig-zag, concave, convex, and the like. The shape of the near net-shaped foam is determined by the shape of the shaped foam article and is not limited to the shapes listed hereinabove.

In the embodiment of the present invention wherein two sides of the foam plank/blank are shaped, the foam plank/blank is cut to form a double-sided foam plank/blank having a first pressing surface and a second pressing surface. During the shaping step, both pressing surfaces of the double-sided foam plank/blank are shaped to form a double-sided shaped foam article.

The term ‘double-sided foam blank’ is used to describe a foam blank having two pressing surfaces which are cut from a foam plank having a top and bottom surface wherein neither of the pressing surfaces of the double-sided foam blank are the plank's top surface or bottom surface. The foam plank with two pressing surfaces may further be cut to provide a double-sided foam blank. In this case, the double-sided foam blank is removed from and/or separated from the double-sided foam plank prior to shaping. One or more cuts may be necessary to prepare the pressing surfaces for the one or more double-sided foam plank/blank. A first cut surface of the double-sided foam plank/blank becomes the first pressing surface and a second cut surface of the double-sided foam plank/blank becomes the second pressing surface. Multiple cuts (e.g., 2, 3, 4, 5, or more) will form multiple (e.g., 2, 3, 4, 5, or more) foam planks/blanks. Alternatively, one or more double-sided foam plank/blank may be cut and or assembled from a single foam plank.

The forming of the shaped foam articles is surprisingly enhanced by using a double-sided foam blank cut from a foam plank that has at least one direction where at least one of C_{E}/C_{T}, C_{V}/C_{T} and C_{H}/C_{T} is at least 0.4 said one of C_{E}/C_{T}, C_{V}/C_{T} and C_{H}/C_{T} (compressive balance), C_{E}, C_{V} and C_{H} being the compressive strength of the cellular polymer in each of three orthogonal directions E, V and H where one of these directions is the direction of maximum compressive strength in the foam and C_{T} equals the sum of C_{E}, C_{V} and C_{H}.

In one embodiment of the present invention, the compressive strength of the first pressing surface CS₁ₛₜ of the double-sided foam blank is different than the compressive strength of the second pressing surface CS_{2nd} of the double-sided foam blank: CS₁ₛₜ≠CS_{2nd}. If the compressive strength of the first and second pressing surfaces are different, the difference in percent is calculated by:

% difference=[(CS₁ₛₜ−CS_{2nd})/CS₁ₛₜ]×100

wherein CS₁ₛₜ is the larger compressive strength value.

Preferably, the difference in compressive strength between the first and second pressing surfaces is equal to or less than 60 percent, more preferably equal to or less than 55 percent, more preferably equal to or less than 50 percent, more preferably equal to or less than 45 percent, more preferably equal to or less than 40 percent, more preferably equal to or less than 35 percent, more preferably equal to or less than 30 percent, more preferably equal to or less than 25 percent, more preferably equal to or less than 20 percent, more preferably equal to or less than 15 percent, more preferably equal to or less than 12.5 percent, more preferably equal to or less than 10 percent, more preferably equal to or less than 7.5 percent, more preferably equal to or less than 5 percent, more preferably equal to or less than 2.5 percent, more preferably equal to or less than 1 percent, more preferably equal to or less than 0.5 percent, more preferably equal to or less than 0.25 percent, more preferably equal to or less than 0.1 percent, more preferably equal to or less than 0.05 percent, and most preferably the difference in compressive strength between the first and second pressing surfaces is equal to or less than 0.01 percent.

In a preferred embodiment of the present invention, the foam compressive strength at the first pressing surface CS₁ₛₜ of the double-sided foam blank is equal to the foam compressive strength at the second pressing surface CS_{2nd} of the double-sided foam blank:

CS₁ₛₜ=CS_{2nd}.

The process of the present invention is ideally suited to make such shaped foam articles as a foam trim, an automotive part, a decorative insulation, safety equipment, packaging material, form-fit insulation, an insulated sheathing, an insulated building cladding, a decorative trim, a vinyl siding backing, an integrated radiant floor heating panel, a sandwich panel with non-planer faces, furniture, a composite panel, foot wear, a buoyancy part for boats or watercraft, a decoration product for a craft application, an energy absorption component in a helmet, an energy absorption component in a military application, a component of a crash barrier, an energy absorption component in an automotive article, a foam composite part for windmill turbine blades, composite roof tiles, or a cushion packaging article.

### Test Methods

The density profile through the thickness of each foam blank was tested using a QMS Density Profiler, model QDP-01X, from Quintek Measurement Systems, Inc. Knoxyille, Tenn. The High Voltage kV Control was set to 90 percent, the High Voltage Current Control was set to 23 percent and the Detector Voltage was approximately 8v. Data points were collected every 0.06 mm throughout the thickness of the foam. Approximate thickness of the foam samples in the plane of the x-ray path was 2 inches. Mass absorption coefficients were calculated for each sample individually, based on the measured linear density of the foam part being tested. The skin density, ρₛₖᵢₙ, was reported as a maximum value whereas the core density, ρ_{core}, was averaged within an approximate 5 mm range. The density gradient, in units of percentage, was then computed in accordance with the following equation:

$$Density Gradient ( percent ) = 100 \cdot \frac{( {ρ}_{core} - {ρ}_{skin} )}{{ρ}_{skin}}$$

The compressive response of each material was measured using a Materials Test System equipped with a 5.0 displacement card and a 4,000 lbf load card. Cubical samples measuring the approximate thickness of each plank were compressed at a compressive strain rate of 0.065 s⁻¹. Thus, the crosshead velocity of the MTS, in units of inches per minute, was programmed in accordance with the following equation:

Crosshead Velocity=Strain Rate*Thickness*60

where the thickness of the foam specimen is measured in units of inches. The compressive strength of each foam specimen is calculated in accordance with ASTM D1621 while the total compressive strength, C_{ST}, is computed as follows:

C_{ST}=C_{SV}+C_{SE}+C_{SH}

where C_{SV}, C_{SE} and C_{SH} correspond to the compressive strength in the vertical, extrusion and horizontal direction respectively. Thus, the compressive balance, R, in each direction can be computed as shown below:

R_{V}=C_{SV}/ST

R_{E}=C_{SE}/C_{ST}

R_{H}=C_{SH}/C_{ST}

Open cell content was measured by using an Archimedes method on 25 mm×25 mm×50 mm samples.

While certain embodiments of the present invention are described in the following example, it will be apparent that considerable variations and modifications of these specific embodiments can be made without departing from the scope of the present invention as defined by a proper interpretation of the following claims.

Percent crack reduction Cᵣ can be determined from the ratio of the rough crack value R_{cv} to the smooth crack value S_{cv} by the following formula:

Cᵣ=(1−R_{cv}/S_{cv})*100

Wherein crack values are manually calculated for a shaped foam article pressed by a die or mold with a smooth cavity surface S_{cv} by first measuring the length of each crack in the shaped foam article (or a specified portion thereof) made from a die or mold with a smooth cavity surface and then adding each of the individual crack lengths together to get an overall smooth crack value S_{cv} in units of length. Crack values are manually calculated for a shaped foam article pressed by a die or mold with a reduced-slip cavity surface R_{cv} by first measuring the length of each crack, if any, in the shaped foam article (or the same specified portion as used in the shaped foam article pressed from the die or mold with a smooth cavity surface) made from a die or mold with a reduced-slip cavity surface and then adding each of the individual crack lengths together to get an overall reduced-slip crack value R_{cv} in units of length.

1. A method for stamping one or more shaped foam article in a stamping press having a first die affixed to a ram and an optional second die affixed to a stationary bolster plate wherein the ram is capable of moving towards and away from the bolster plate comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has
(i)(a) a vertical compressive balance equal to or greater than 0.4
and
(i)(b) one or more pressing surface;
(ii) placing the foam plank between the ram comprising the first die and the bolster plate optionally comprising the second die when the ram is away from the bolster plate;
(iii) moving the ram towards the bolster plate;
(iv) shaping the one or more pressing surface of the foam plank into one or more shaped foam article and, if present, surrounding continuous unshaped foam plank by
(iv)(a) contacting the one or more pressing surface of the foam plank with the die(s), said die(s) comprises one or a plurality of cavities each cavity having a perimeter defining the shape of the shaped foam article and a cavity surface
and
(iv)(b) pressing the foam plank with the die whereby forming one or more shaped foam article;
(v) moving the ram away from the bolster plate; and
(vi) removing the one or more shaped foam article from between the ram and the bolster plate.

2. The method of claim 1 further comprising the step of:
(i)(c) cutting the foam plank to form a foam blank prior to (ii) placing the foam blank between the ram and the bolster plate.

3. The method of claim 1 or 2 wherein the ram is operated by hydraulically or mechanically means.

4. The method of claim 1 or 2 wherein the top surface of the foam plank/blank has a pressing surface wherein said surface is the surface that is shaped.

5. The method of claim 1 or 2 wherein the top surface and the bottom surface of the foam plank/blank each have a pressing surface wherein both the top surface and the bottom surface are shaped.

6. The methods of claim 1 or 2 wherein each cavity in the die affixed to the ram is defined by a trimming rib and further comprises the step:
(iv)(b)(c) trimming each shaped foam article thus formed from the surrounding continuous unshaped foam plank/blank,
wherein shaping and trimming of the one or more shaped foam article happens concurrently.

7. The method of claim 1 or 2 wherein the foam has a cell gas pressure equal to or less than 1 atmosphere.

8. The method of claim 1 or 2 wherein the thermoplastic polymer is polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

9. The method of claim 1 or 2 wherein the blowing agent is a chemical blowing agent, an inorganic gas, an organic blowing agent, carbon dioxide, or combinations thereof.

10. A shaped foam article made by the method of claim 1 or 2.
